(19) United States
(12) Patent Application Publication
(10) Pub. No.: US 2018/0086281 A1
(43) Pub. Date: Mar. 29, 2018

(54) PORTABLE 3C APPARATUS HOLDER FOR AN AUTOMOBILE

(71) Applicant: Chukuan Chiou, Encinitas, CA (US)

(72) Inventor: Chukuan Chiou, Encinitas, CA (US)

(21) Appl. No.: 15/280,899

(22) Filed: Sep. 29, 2016

(51) Int. Cl. B60R 11/02

(52) U.S. Cl. CPC B60R 11/02; B60R 11/0211; B60R 2011/0008; B60R 11/0252; B60R 11/0258; B60R 11/0241

(57) ABSTRACT

A portable 3C (Computing, Communication, and Consumer) apparatus holder for an automobile includes a clamp; a magnet assembled with the clamp by a fasten device; and a supporting pad having a front surface and a bottom surface opposite to each other, wherein the magnet is depicted on the bottom surface of the supporting pad to adsorb a portable 3C apparatus placed on the front surface of the supporting pad.

### BACKGROUND OF THE INVENTION

### Field of the Invention

The present invention relates to a portable 3C (Computing, Communication, and Consumer) apparatus holder, and in particular relates to a portable 3C apparatus holder for an automobile.

### Description of the Related Art

Increasing with portable 3C apparatuses with touch panels such as smart phones, smart pad, PDAs, laptops, driving recorders or navigation machines, becomes more and more popular, various portable 3C apparatus holders for an automobile are provided. The versatile magnetic cell phone holder is one of the most popular holder, but it does not quite secure owing to it applies glue to fasten on the dash board.

In order to resolve above-mentioned problem, this invention provides a novel portable 3C apparatus holder for an automobile which is characterized by utilizing a clamp to secure the holder on the outlet of the air condition of an automobile and adsorbing the 3C apparatus by a magnet assembled with the clamp by a fasten device.

### SUMMARY OF THE INVENTION

A feature of this invention provides a portable 3C apparatus holder for an automobile, comprising: a clamp; a magnet assembled with the clamp by a fasten device; and a supporting pad having a front surface and a bottom surface opposite to each other, wherein the magnet is depicted on the bottom surface of the supporting pad to adsorb a portable 3C apparatus placed on the front surface of the supporting pad.

Another feature of this invention provides a portable 3C apparatus holder for an automobile as mentioned above, wherein the magnet is a versatile magnet.

Another feature of this invention provides a portable 3C apparatus holder for an automobile as mentioned above, wherein the versatile magnet is a versatile magnetic ball.

Another feature of this invention provides a portable 3C apparatus holder for an automobile as mentioned above, wherein the bottom surface of the supporting pad further comprises a cavity for accommodating the magnetic ball.

Another feature of this invention provides a portable 3C apparatus holder for an automobile as mentioned above, wherein the clamp is used to clamp the outlet of the air condition of an automobile.

Another feature of this invention provides a portable 3C apparatus holder for an automobile as mentioned above, wherein the clamp is a sturdy clamp.

Another feature of this invention provides a portable 3C apparatus holder for an automobile as mentioned above, wherein the fasten device is a screw.

Another feature of this invention provides a portable 3C apparatus holder for an automobile as mentioned above, wherein the portable 3C apparatus includes a cell phone, a pad, a PDA, a laptop, a driving recorder or a navigation machine.

Another feature of this invention provides a portable 3C apparatus holder for an automobile as mentioned above, further comprising a first nut sandwiched between the clamp and the magnet.

Another feature of this invention provides a portable 3C apparatus holder for an automobile as mentioned above, further comprising a second nut sandwiched between the clamp and the screw.

### BRIEF DESCRIPTION OF THE DRAWINGS

FIG. 1A is a perspective view of a portable 3C apparatus holder for an automobile according to an embodiment of this present invention.

FIG. 1B is an exploded view of the portable 3C apparatus holder for an automobile as illustrated in FIG. 1A.

FIG. 2 is a perspective view of a cell phone adsorbed by the portable 3C apparatus holder for an automobile according to an embodiment of this present invention.

### DETAILED DESCRIPTION OF THE INVENTION

The making and using of the embodiments of the present disclosure are discussed in detail below. However, it should be noted that the embodiments provide many applicable inventive concepts that can be embodied in a variety of specific methods. The specific exemplary embodiments discussed are merely illustrative of specific methods to make and use the embodiments, and do not limit the scope of the disclosure.

### Exemplary Embodiment

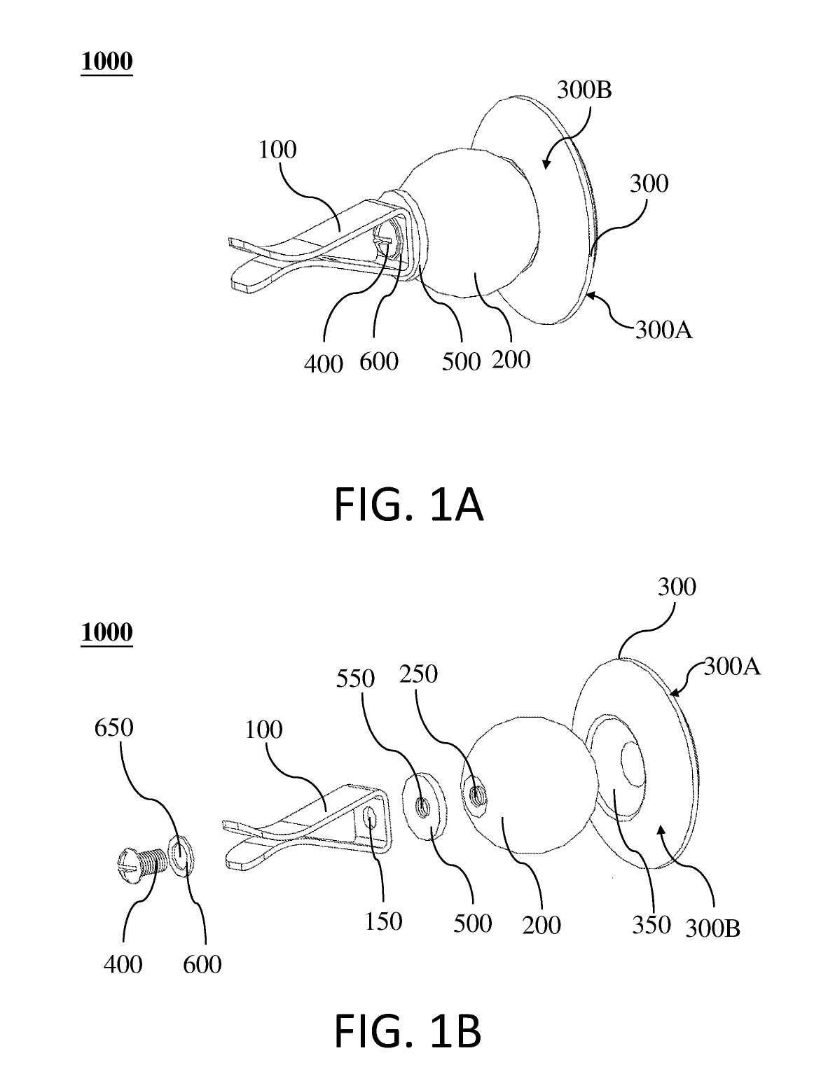

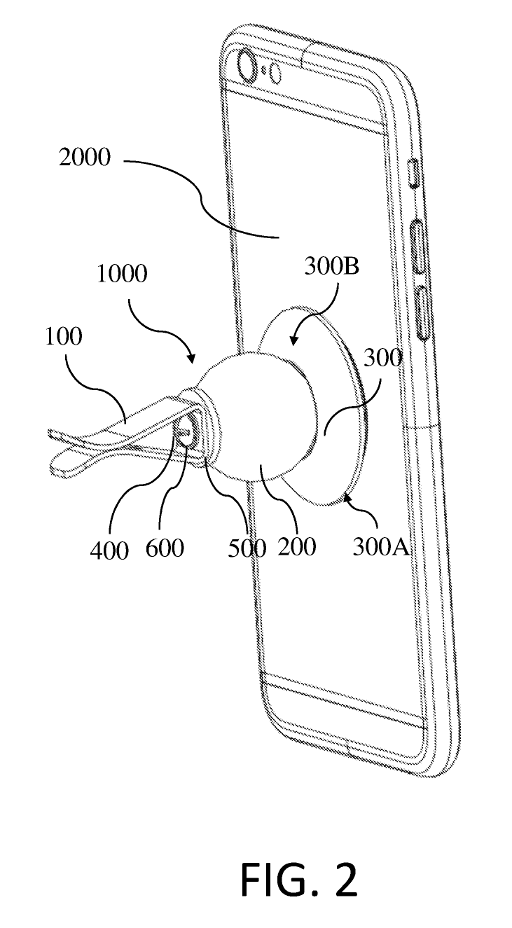

A detailed description of the portable 3C apparatus holder 1000 is given below with reference to the accompany FIGS. 1A-1B and FIG. 2.

First, please refer to FIG. 1A. As the perspective view of FIG. 1A shown, the portable 3C apparatus holder 1000 comprises a clamp 100, a magnet 200 and 1 supporting pad 300. The magnet 200 is assembled with the clamp 100 by a fasten device 400. The supporting pad 300 has a front surface 300A and a bottom surface 300B opposite to each other, and the magnet 200 is depicted on the bottom surface 300B of the supporting pad 300 to adsorb a portable 3C apparatus (not shown) placed on the front surface 300A of the supporting pad 300. Besides, there is a first nut 500 sandwiched between the magnet 200 and the clamp 100, and there is a second nut sandwiched between the fasten device 400 and the clamp 100. The clamp 100 of this embodiment is a sturdy clamp which can also be replaced with other clamps in other embodiments of this present invention. The magnet 200 of this embodiment is a versatile magnet, and in particular a versatile magnetic ball, which can also be replaced with versatile magnets with other shapes in other embodiments of this present invention. The fasten device 400 of this embodiment is a screw which can also be replaced with other fasten device 400 with similar functions.

Second, please refer to FIG. 1B. As the exploded view of FIG. 1B shown, the bottom surface 300 of the supporting pad 300 has a cavity 350; the magnet 200 has a tapping hole 250; the first nut 500 has a tapping hole 550; the second nut 600 has a tapping hole 650, and the clamp has an opening 150. The clamp 100 and the magnet 200 are assembled by screwing the fasten device 400 into the tapping hole 250 of the magnet 200 by passing through the tapping hole 650 of the second nut 600, the opening 150 of the clamp 100, and the tapping hole 550 of the first nut 500. The magnet 200 is accommodated into the cavity 350 of the supporting pad 300, and the portable 3C apparatus holder 1000 can be secured on the outlet (not shown) of the air condition of an automobile by the clamp 100.

Finally, as the perspective view of FIG. 2 shown, the cell phone 2000 is adsorbed on the front surface 300A of the supporting pad 300 via the magnet 200 accommodated into the cavity 350 of the supporting pad 300, and the portable 3C apparatus holder 1000 is secured on the outlet (not shown) of the air condition of an automobile by the clamp 100. The cell phone 2000 can also be replaced with other portable 3C apparatuses such as smart phones, smart pad, PDAs, laptops, driving recorders or navigation machines.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable 3C (Computing, Communication, and Consumer) apparatus holder for an automobile, comprising:
a clamp;
a magnet assembled with the clamp by a fasten device; and
a supporting pad having a front surface and a bottom surface opposite to each other, wherein the magnet is depicted on the bottom surface of the supporting pad to adsorb a portable 3C apparatus placed on the front surface of the supporting pad.

2. The portable 3C holder for an automobile as claimed in claim 1, wherein the magnet is a versatile magnet.

3. The portable 3C holder for an automobile as claimed in claim 2, wherein the versatile magnet is a versatile magnetic ball.

4. The portable 3C holder for an automobile as claimed in claim 3, wherein the bottom surface of the supporting pad further comprises a cavity for accommodating the magnetic ball.

5. The portable 3C holder for an automobile as claimed in claim 2, wherein the clamp is secured on the outlet of the air condition of an automobile.

6. The portable 3C holder for an automobile as claimed in claim 3, wherein the clamp is a sturdy clamp.

7. The portable 3C holder for an automobile as claimed in claim 2, wherein the fasten device is a screw.

8. The portable 3C holder for an automobile as claimed in claim 2, wherein the portable 3C apparatus comprises a cell phone, a pad, a PDA, a laptop, a driving recorder or a navigation machine.

9. The portable 3C holder for an automobile as claimed in claim 2, further comprising a first nut sandwiched between the clamp and the magnet.

10. The portable 3C holder for an automobile as claimed in claim 2, further comprising a second nut sandwiched between the clamp and the screw.
